(19) United States
(12) Patent Application Publication
(10) Pub. No.: US 2019/0360295 A1
(43) Pub. Date: Nov. 28, 2019

(54) SYSTEM AND METHOD FOR CONTROLLING A BLOWOUT PREVENTER SYSTEM IN AN OIL RIG

(71) Applicant: General Electric Company, Schenectady, NY (US)

(72) Inventors: Parag Mantri, Bangalore (IN); John S. Holmes, Houston, TX (US); Muralikrishna Rangharajhan, Bangalore (IN); Sriram Sundar, Bangalore (IN); Shweta Gupta, Bangalore (IN); Sandeep Dhar, Bangalore (IN)

(73) Assignee: General Electric Company, Schenectady, NY (US)

(21) Appl. No.: 16/331,791

(22) PCT Filed: Aug. 3, 2017
(86) PCT No.: PCT/US2017/045198

§ 371 Date: Mar. 8, 2019

(30) Foreign Application Priority Data
Sep. 9, 2016 (IN) 201641030950

(51) Int. Cl. E21B 33/064; E21B 33/035; E21B 33/038

(52) U.S. Cl. CPC E21B 33/064; G05B 15/02; E21B 33/038; E21B 33/0355

(57) ABSTRACT

A control system and method for a blowout preventer (BOP) system in an oil rig is provided. An input module generates control inputs for required components of the blowout preventer system, and transmits the control inputs simultaneously as an operational input and a numerical input, where the operational input is transmitted to the required component of the blowout preventer system. A synchronized model is coupled to the input module to receive the numerical input, and to replicate an operation of the blowout preventer system based on the numerical input. The synchronized model also generates one or more model outputs based on the replication of the operation of the blowout preventer system.

### BACKGROUND

This disclosure relates generally to oil rigs, and more particularly to system and methods for controlling a blowout preventer system in an oil rig.

Deepwater drilling for oil and gas is typically done from floating vessels like a ship or a floating rig. Such floating vessels may be anchored, but for deep water the currently dominating practice is to use dynamic positioning, where the floating vessel is kept in the desired position by a dynamic positioning system, which is a computer system that records the position as measured by position reference systems such as GPS receivers, taut-wires or hydro-acoustic systems.

A subsea blowout preventer (also referred as, “BOP” and “blowout preventer (s)” herein) is a safety device used during the drilling operation of oil and gas wells. It is typically a large, specialized high pressure valve or similar mechanical device, that is used to seal, control and monitor oil and gas wells to prevent blowout, i.e. an uncontrolled release of crude oil and/or natural gas from well. They are usually installed redundantly in stacks. The primary function of the BOP is to open and close the well bore.

As mentioned herein above, blowout preventers are used to cope with extreme erratic pressures and uncontrolled flow that are called formation kicks, (referred generally as “kick”), emanating from a well reservoir during drilling. Kicks can lead to a potentially catastrophic event known as a blowout. In addition to controlling the downhole (occurring in the drilled hole) pressure and the flow of oil and gas, blowout preventers are intended to prevent tubing (e.g. drill pipe and well casing), tools and drilling fluid from being blown out of the well bore (also known as bore hole, the hole leading to the reservoir) when a blowout threatens. Blowout preventers are critical to the safety of crew, rig (the equipment system used to drill a wellbore) and environment.

A subsea BOP includes two major types of blowout preventers, annular (also known as spherical) and ram. Annular BOPs are usually mounted to the very top of the BOP stack. Below the annular BOP, typically, two, three, or four ram BOPs are installed. An annular BOP, can close the well through different devices such as a drill string, and the different types of rams can close the well with the drill-pipe inside the well. In an emergency, shear rams can be used to cut the pipe inside the well if necessary. All the rams are hydraulically activated.

To control a blowout, the BOP stack is fitted with hydraulic lines which allow drillers or operators to pump a heavier drilling fluid in the well (kill line), or to evacuate the lighter fluid from the well (choke line). There are surface components in the BOP system, such as high pressure units and accumulators, that are connected through hydraulic lines with the subsea BOP stack for this fluid management. The service pressure of the BOP is chosen to support the maximum pressure encountered during drilling operations. The pressure range is usually from 5000 psi (pound-force per square inch) to 20000 psi (345 bar to 1380 bar approximately).

Being installed in subsea, it is difficult to adequately know the operation and performance of the subsea BOP. Any identification of a problem in subsea BOP makes it necessary to abort drilling operations and lift the subsea BOP up from the seafloor to platform, or perform underwater repair. This results in significant additional costs of drilling as the rig will be out of operation for one day or more. Moreover, sometimes, even software errors in the BOP control systems may lead to potentially dangerous situations that can cause a blowout.

For controlling an operation of the BOP, ROV (Remotely Operated Vehicles) are sometimes used, that are underwater vessels used with the oil rigs, and have with cameras and robotic arms, and a series of sensors such as pressure and heading sensors. ROV's are controlled and operated from the surface through a cable that supplies electrical energy and command signals to the ROV, and transfers camera images and sensor signals back to the surface.

Alternately, shallow water control systems may be used for controlling the operation of BOP, that use a hydraulic system for signal transmission. Functions are activated using hydraulic fluid to activate the pilot on a pod, or control system valve. This solution can be used for water depths up to 5000 feet.

These days, MUX (Multiplexed) BOP control systems are commonly used for drilling at water depths over 3500 feet. In MUX BOP control systems electrical signals are transmitted from the platform to the BOP. Such systems typically use computers or PLC's (Programmable Logic Controllers) on the platform that communicate with subsea electronics contained in water-tight pods on the subsea BOP. This solution allows for the programming of logics functions and automatic sequencing of operations. Redundant hardware is used to improve reliability.

For monitoring of the BOP operation, to ensure safe operation, usually the sensor based feedback is used. Only sensor based monitoring and control of the operation of BOP continues to be a challenge, since the components are subsea, at great depths, and there exists a possibility of delay in tracking an issue such as a mal-functioning in any component of BOP, purely based on sensor feedback. The sensor itself may not function properly leading to improper interpretation of sensor feedback.

### BRIEF DESCRIPTION

In one aspect, a control system for a blowout preventer (BOP) system in an oil rig is provided. The control system includes an input module for generating one or more control inputs for one or more components of the BOP system, and transmitting the one or more control inputs simultaneously as an operational input and a numerical input, where the operational input is transmitted to one or more components of the BOP system. A synchronized model is coupled to the input module for receiving the numerical input, and for replicating an operation of the BOP system based on the numerical input. The synchronized model also generates one or more model outputs based on the replication of the operation of the BOP system. An output module is provided for receiving the one or more model outputs, where the one or more model outputs are used for at least one of monitoring and controlling an operation of the blowout preventer system.

In another aspect, a method for controlling a blowout preventer (BOP) system in an oil rig is provided. The method includes generating one or more control inputs for the BOP system, and transmitting the one or more control inputs simultaneously as an operational input and a numerical input, where the operational input is transmitted to the BOP system; and simultaneously the control input is converted into a numerical input and sent to a synchronized model for replicating an operation of the BOP system. The synchronized model also generates one or more model outputs, where the one or more model outputs are used for at least one of monitoring and controlling an operation of the BOP system.

In another aspect a computer program product for implementing the method and system described herein above is provided.

### DRAWINGS

These and other features, aspects, and advantages of the present invention will become better understood when the following detailed description is read with reference to the accompanying drawings in which like characters represent like parts throughout the drawings, wherein:

FIG. 1 is an exemplary diagrammatic representation of an oil rig;

FIG. 2 is an exemplary representation of some components of a subsea BOP stack;

FIG. 3 is an exemplary block diagram representation of a BOP system of the oil rig;

FIG. 4 is a diagrammatic representation of a BOP control system according to an aspect of the invention;

FIG. 5 is a block diagram representation of control inputs generated in an input module of the BOP control system;

FIG. 6 is a block diagram representation of high level functional modules with their corresponding signals;

FIG. 7 is a waveform representation of sample signals for some of the components of the BOP system;

FIGS. 8-10 are diagrammatic representations of exemplary control outputs from the synchronized model of the invention; and

FIG. 11 is a flowchart representation of an exemplary method for controlling a blowout preventer system in an oil rig.

### DETAILED DESCRIPTION

The singular forms “a”, “an”, and “the” used herein include plural references unless the context clearly dictates otherwise.

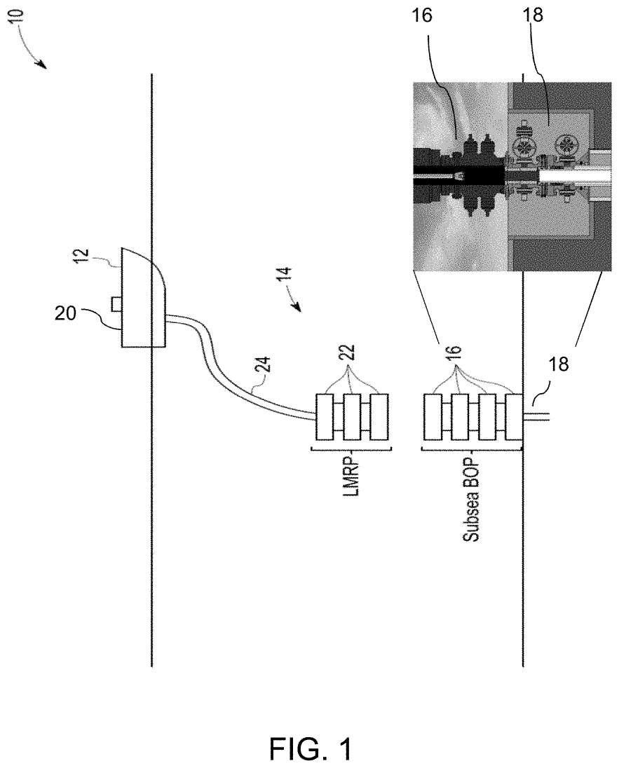

A typical oil rig 10 is shown in FIG. 1. The oil rig 10 includes a floating installation 12, (or an on-shore remote controlling installation), and a BOP system 14. The BOP system 14 includes one or more subsea BOP stacks 16 that are mounted on a wellhead 18 at a seafloor, below which is an oil and gas reservoir. The BOP system 14 also includes surface components 20.

The subsea stacked blowout preventers 16 can be of varying types and functions, and include several auxiliary components, such as subsea BOP stack of valves, test valve, kill and choke lines, riser joint, electrical, communication, and hydraulic lines, control pods, and a support frame.

The surface components 20 include hydraulic accumulators, high pressure units (HPU), fluid reservoir units, and associated pumps, valves, hydraulic, electrical and communication lines, hydraulic connectors, and other such components for fluid control and management for subsea BOP operation.

An LMRP (Lower Marine Riser Package) 22 is mounted at the lower end of a marine riser 24, and is used to connect to the subsea BOP stack 16. The LMRP 22, also has a stack of valves to control the opening and closing of the lower end of the marine riser 24. For the purpose of the invention the LMRP is considered to be a part of subsea BOP 16.

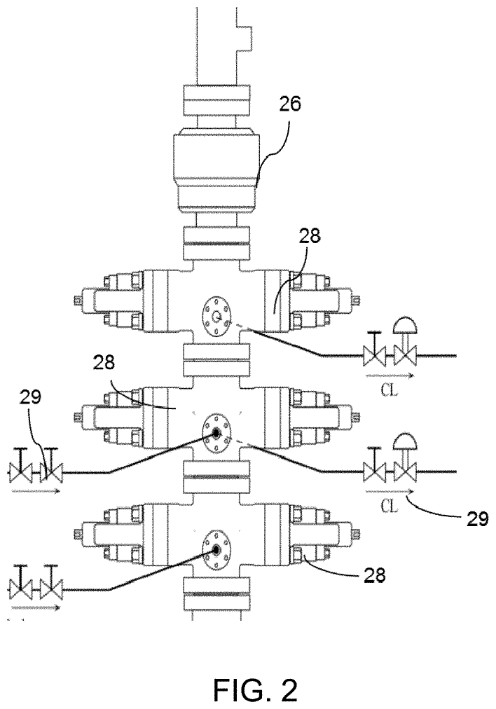

An overview of the subsea BOP stack with some components (annular valve 26, rams 28, and hydraulic connections 29) is shown in FIG. 2. It would be known to those skilled in the art that the subsea BOP stack of valves, will typically include:
An annular valve that closes the wellbore, both when the wellbore is empty and when there is a drill pipe or casing in the drilling riser.
Pipe rams which are valves that close the subsea BOP when there is a drill pipe in the wellbore.
Blind rams that are valves that close the wellbore when there is no drill pipe in the wellbore
Shear rams, which is a valve that cut off the drill pipe and closes the wellbore.
Drilling spool used to connect the choke line and the kill line.

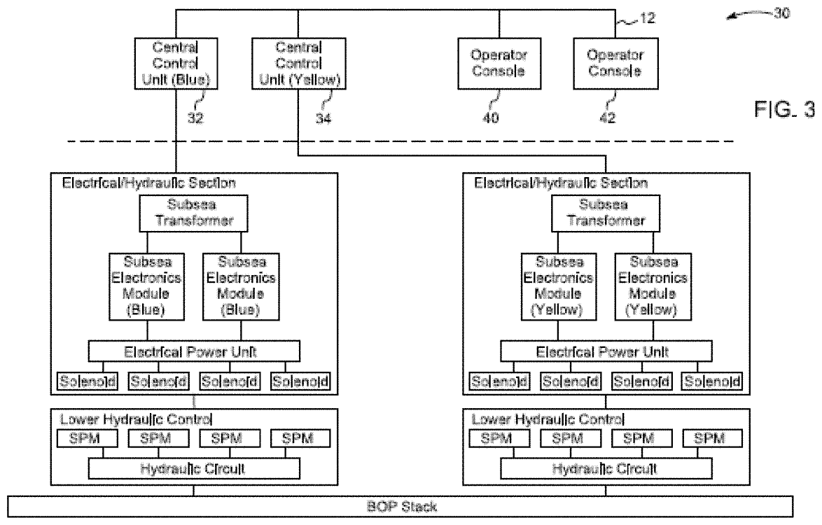

FIG. 3 illustrates a multiplexed BOP control system 30 used for the BOP system 14 of FIG. 1. On the platform or vessel, sometimes referred to as floating installation 12 of FIG. 1, two identical computer implemented Central Control Units (CCUs), one CCU is designated as the blue system 32 and one CCU is designated as the yellow system 34 (there can be more control units for redundancy). The Central Control Units at the platform communicate with a respective subsea electrical and hydraulic section 36, and lower hydraulic control 38. As shown in FIG. 3, each electrical and hydraulic section 36 typically includes a subsea transformer, a pair of subsea electronics module (SEM), electrical power unit, and solenoids, with appropriate electrical connections. The electrical and hydraulic section is coupled to the lower hydraulic control section 38 that has the SPM (sub plate mounted) valves and the hydraulic circuit that connects to the BOP stack 16. Sections 36 and 38 together are generally referred as pods. The Central Control Units 32, and 34 are connected to a number of operator consoles 40, 42 on the platform 12. The central control units 32, 34 are also connected through a signal transmission system that comprises e.g. serial communication lines and fiber optic communication lines to the blue pod 36 and the yellow pod 38.

The drilling operators use operator consoles 40, 42, to control the subsea BOP valves and receive signals from subsea BOP sensors in the subsea BOP. The operator consoles 40, 42 are connected to the Central Control Units 32, 34 at the floating installation 12. The operators select which of the redundant Central Control Units 32, 34 at the platform and which of the redundant SEMs will be used to control the subsea BOP 16.

Aspects of the invention are applicable for each of the Central Control Units 32, 34 described herein above. The BOP control system 50 described herein below, refers to each of the Central Control Units 32, 34 with enhanced capabilities enabled through the aspects of the invention. The description herein below is focused on these enhanced capabilities.

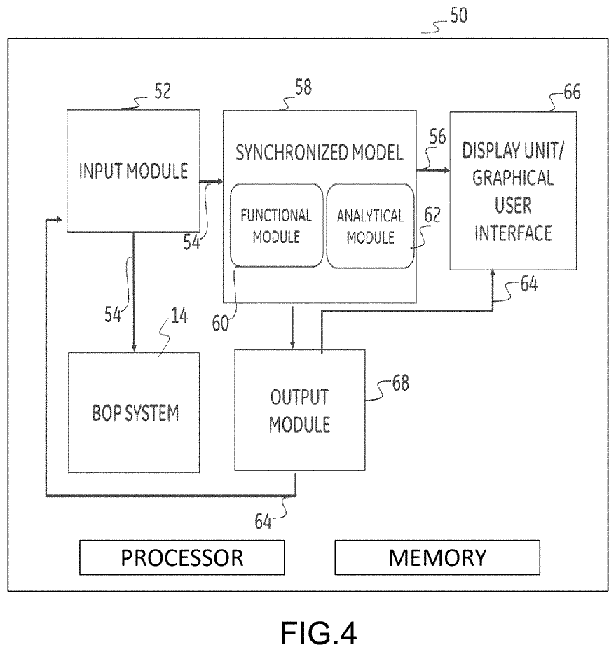

FIG. 4 is a diagrammatic representation of an exemplary embodiment of the BOP control system 50 (an enhancement of the BOP control system 30 of FIG. 3) according to one aspect of the invention. The BOP control system 50 includes an input module 52 for generating control inputs 54 for one or more components of the BOP system 14. The one or more components referred herein include the surface components, and/or subsea BOP components. Control inputs 54, include control inputs for surface components, such as, pumps and accumulators, and subsea components such as Ram Subsea control inputs include signals to solenoids (“on” or “off” in real time) which actuate the SPM (Sub Plated Mounted) valves, which in turn, perform the BOP functions. Surface control inputs include “on” or “off” state for each pump (for example totally three pumps, in one embodiment), as per the pressure in the accumulator and pump logic pre-defined in the control system 50. It may be further understood by those skilled in the art that the input module is implemented using a processor and non-transitory storage medium of a computing system, and includes codes and routines for implementing the specific functionality.

The input module 52 is coupled to the BOP system 14 through wired or wireless means (coupling herein implies being in communication), that have been briefly described in the different embodiments of Central Control Units 32, 34 and pods 36, 38, herein above. The control inputs 54, are additionally sent to a synchronized model 58 (referred as “synchronized model” herein below) of the BOP system 14 in the BOP control system 50. It would be appreciated by those skilled in the art that the synchronized model 58 may be integrated within a central computing system for the BOP control system 50 or made available on a separate dedicated computing system that is communicatively linked to the central computing system, and more specifically to the input module 52 present in the central computing system. It may be further understood by those skilled in the art that the synchronized model 58 is implemented using a processor and non-transitory storage medium of the same computing system, as that used for the input module or a separate dedicated computing system, as mentioned herein above. Further, the synchronized module includes codes and routines for implementing the specific functionality described herein.

It may be further noted by those skilled in the art that the synchronized model 58 receives the control inputs 54 from the input module 52 at the same time, i.e. simultaneously, when the control inputs 54 are transmitted to the BOP system 14. These control inputs 54 are converted into respective numerical inputs for the synchronized model 58, whereas the BOP system 14 receives these control inputs 54 as operating inputs in the form of electrical signals or as acoustic signals, or other means of operating the one or more components of the BOP system 14.

In the exemplary embodiment, the synchronized model 58 is a physics based model, that incorporates all the functionalities of the BOP system 14 (including surface components and subsea BOP) by converting the underlying physics of each functionality into modular functional modules 60. The synchronized model 58 also includes some analytical modules 62 that use the functional modules 60 to generate model outputs 64.

An example of physics based modelling deployed in the synchronized model 58 is given here. It would be understood by those skilled in the art that different valves of the subsea BOP 16 are operated by solenoids which in turn receive their operational inputs from the BOP control system 50, and convert operational inputs to mechanical motion of an associated cylinder. During closing operation of the valve, a force is exerted on the associated cylinder. To replicate this operation in traditional simulation models, Force-Displacement curves obtained from Finite Element analysis, are used. These curves are complicated and using these curves for simulation is numerically intensive. The synchronized model, instead makes use of linear equivalent, for example, a spring stiffness impact for an equivalent for Force-Displacement curves. This technique significantly reduces the computation time. For each operation in the surface components and subsea BOP, a corresponding mapping of the corresponding operation is done in the synchronized model using different physics based applications.

Through this mapping, the actual operation of the BOP system is replicated (indicated by reference numeral 56) on a graphical user interface (display unit 66) of a designated computing system (central computing system or the separate dedicated computing system). Whatever impact the control inputs have on the blowout preventer, the same impact is created in the synchronized model and displayed on the graphical user interface 66 of the computing device. It would be worthwhile to note here, that the synchronized model 58 relies primarily on control inputs 54 and does not necessarily need any sensor feedback from the sensors deployed for subsea BOP. The synchronized model 58 has the requisite robustness and accuracy to replicate the BOP operations without depending on sensor feedback. This provides a great advantage over the prior art solutions, as sensor data often can be faulty, and the sensor itself can be damaged sometimes.

In an exemplary embodiment, the replicated blowout preventer operation is used for monitoring the operation of the blowout preventer. In another exemplary embodiment, the replicated blowout preventer operation is used by the synchronized model 58 to generate one or more model outputs 64 as shown in FIG. 4, based on an operation data from the functional modules 60.

The model outputs 64 are useful for either monitoring or for controlling the operation of the BOP system. These model outputs 64 are sent to an output module 68, which in one exemplary embodiment is the same graphical user interface 66 on which the replicated operation of the blowout preventer is displayed. Alternately, the output module 68 may be located on a separate communication device, where the synchronized model 58 is communicatively linked to the separate communication device. These model outputs 64 may be used by a user (the user referred herein may be an operator for the blowout preventer operation, or a control system programmed to receive the model outputs 64 and use it for user-defined control and/or monitoring actions) to convert them into control inputs 54, or to merely store the model outputs 64 for further analysis, useful for monitoring the operation of the BOP system. The output module 68 referred herein, is implemented using a processor and non-transitory storage medium, and includes codes and routines for implementing the specific functionality.

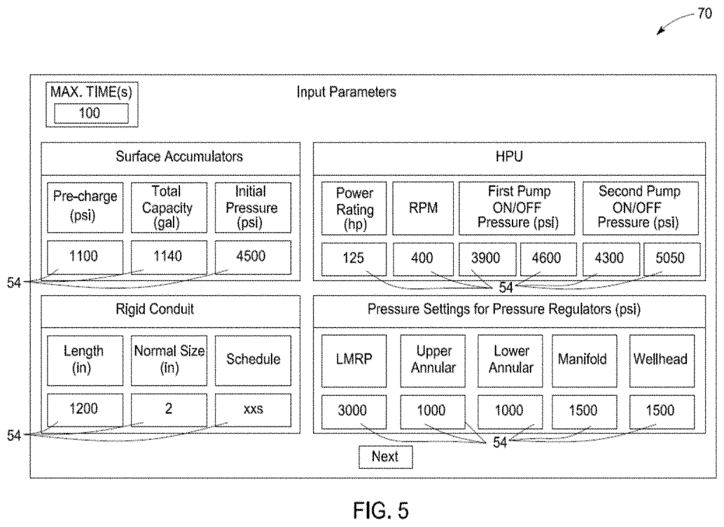

Further details of some aspects of the BOP control system and synchronized model are described herein below in reference to FIG. 5-10.

FIG. 5 is a block diagram representation 70 of some sample control inputs 54 generated in an input module 52 of the BOP control system 50 and displayed on a graphical user interface 66, as mentioned herein above in the description of FIG. 4.

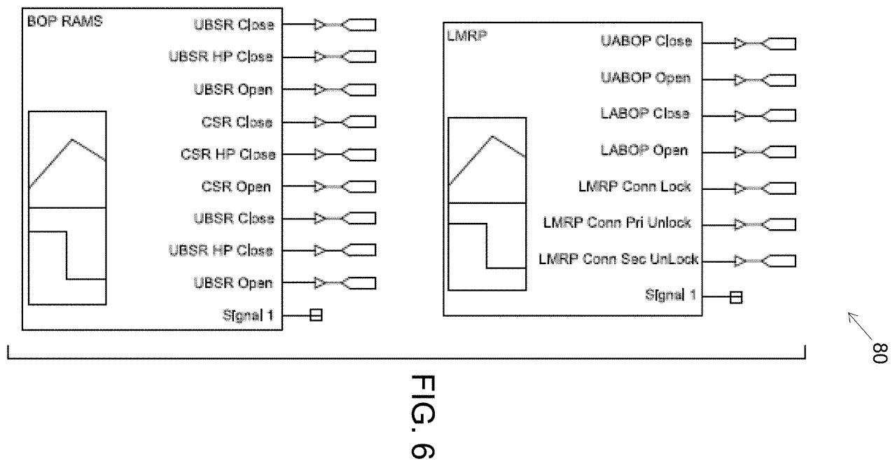

FIG. 6 is a diagrammatic representation 80 of select exemplary functionalities (Close, Open, Lock, Unlock, Signal) of two components, BOP Rams, and LMRP and their associated sub-components, implemented in the synchronized model 58, such as functionality corresponding to components BOP Rams, and LMRP, and their associated signals implemented and replicated in the synchronized model 58. The terms UBSR, UBSR HP, CSR, CSR HP mean Upper Blind Shear Ram, Upper Blind Shear Ram High Pressure, Casing Shear Ram, Casing Shear Ram High Pressure. The terms UA and LA, refer to Upper Annular and Lower Annular, and the terms LMRP Conn, LMRP Conn Pri, and LMRP Conn Sec mean LMRP Connector, LMRP Connector Primary, LMRP Connector secondary respectively. In one exemplary implementation about ninety-six signals for different functionalities corresponding to different components of the BOP have been implemented.

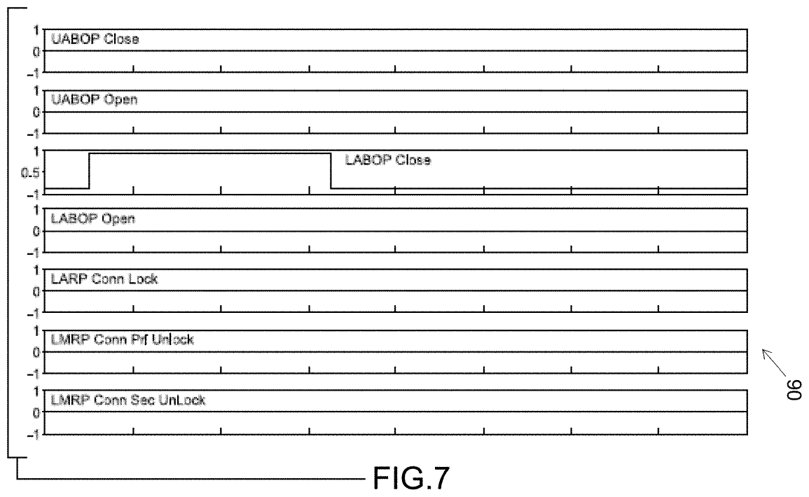

FIG. 7 is an exemplary representation 90 of exemplary representative signals corresponding to a few exemplary non-limiting functionalities of components of the BOP system implemented in the synchronized model 58. The synchronized model includes a signal builder, where each representative signal (also sometimes referred to as solenoid signal) is represented as 0 or 1, where 1 refers to activating the valve, and 0 refers to blocking the valve.

It may be noted here that each functionality referred herein is based on hydraulic connections of one or more components of the BOP system 14. It would be appreciated here that the functional modules are modular modules having connectivity flexibility to enable different configurations of the one or more components for the blowout preventer. Thus the functional modules are flexible and adaptable such that they can be adapted for different configurations of the blowout preventers. Thus the same synchronized model can be used for different oil wells, which may have different configurations of the blowout preventers.

Different configurations referred herein mean that the hydraulic connections of different components in the blowout preventer may be implemented in a different manner for different functionalities. The synchronized model advantageously adapts to all these different configurations through functional modules that can be re-configured for implementing a particular functionality with the given components and connections for a particular blowout preventer. configured as modular modules, and have connectivity flexibility to enable different configurations of the one or more components for a blowout preventer.

The above aspect of the synchronized model is explained in reference to the tables below. Table 1 includes as an example, an existing state of the different components of the subsea BOP. Referring to Table 1, SPM1-SPM4 are different components (Sub Plate Mounted valves) mentioned in column (b), and are given a component number (component order) as shown in column (a), and the corresponding function states are mentioned in column (function index) (c) and are the functionalities for the corresponding components. As per the control inputs, the desired states have to be changed and are mentioned in column (d). The functional connectors are changed by the synchronized model by changing a sorting order of function index, of the function states to map to the desired states, as shown in Table 2 and Table 3. Thus without changing the component order, new functional modules are created by changing the functional connectors for the new functionalities. This provides flexibility and adaptability for creating new functionalities for the same subsea BOP based on user or control inputs, as well as adapting the synchronized model for different subsea BOPs which may have different component configurations.

TABLE 1

| | | EXISTING | DESIRED |
|---|---|---|---|
| SPM NUMBER | COMPONENT | FUNCTIONAL | FUNCTIONAL |
| (a) | (b) | STATE (c) | STATE (d) |
| 1 | SPM 1 | CSR CLOSE | CSR OPEN |
| 2 | SPM 2 | CSR OPEN | BSR OPEN |
| 3 | SPM 3 | BSR CLOSE | CSR CLOSE |
| 4 | SPM 4 | BSR OPEN | BSR CLOSE |

TABLE 2

| | INDEX AT | INDEX AT |
|---|---|---|
| SPM | EXISTING | DESIRED |
| NUMBER (a) | STATE | STATE |
| 1 | 1 | 2 |
| 2 | 2 | 4 |
| 3 | 3 | 1 |
| 4 | 4 | 3 |

TABLE 3

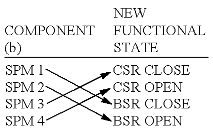

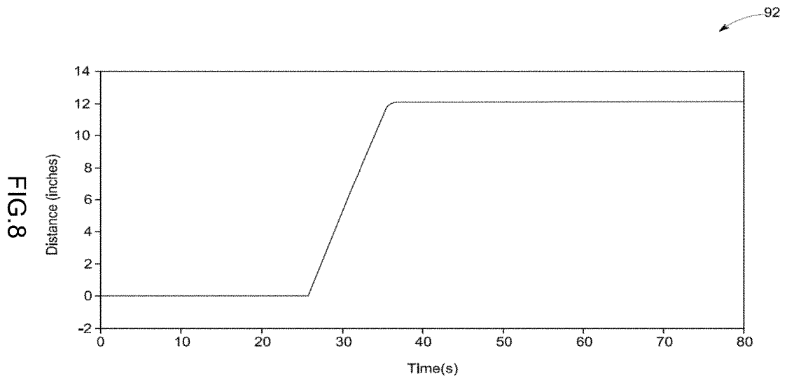

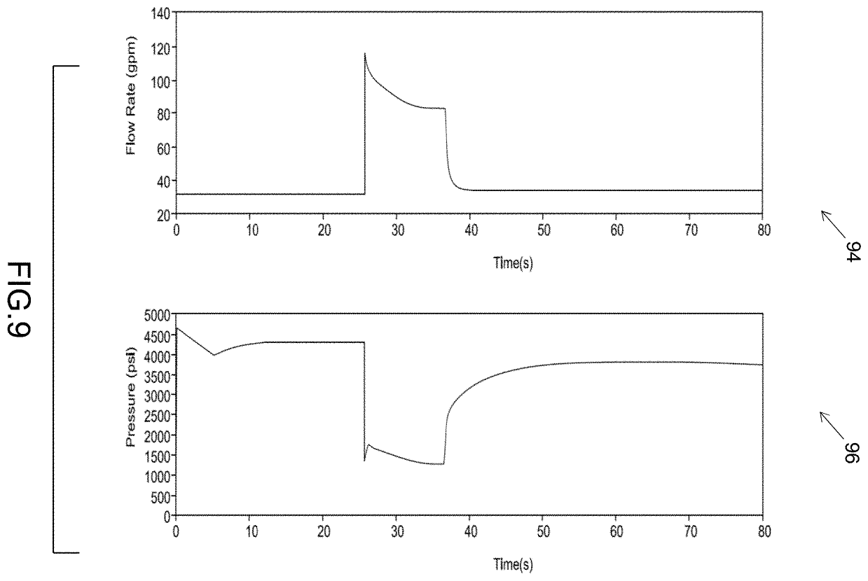

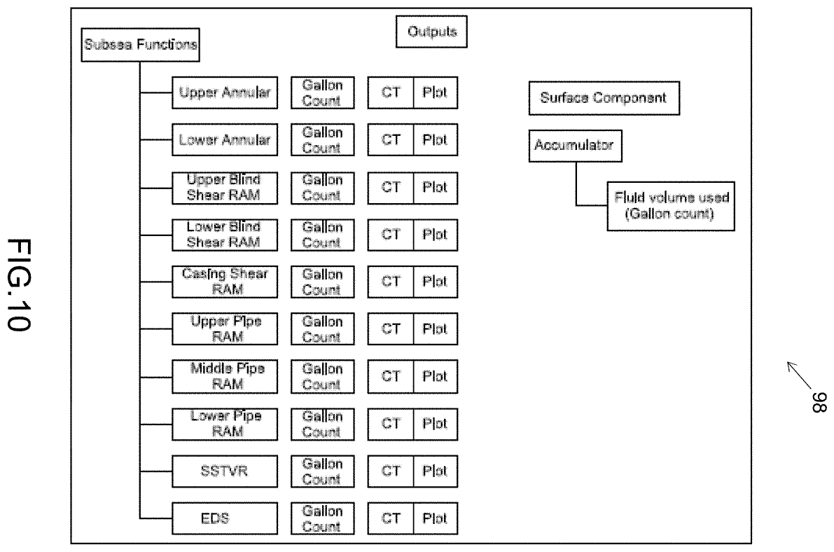

FIG. 8-FIG. 10 are diagrammatic representations of exemplary model outputs 64 from the synchronized model 58 as mentioned in relation with FIG. 4. FIG. 8 is an exemplary output 92, showing ram closing times. FIG. 9 is an exemplary output 94 showing flow rate at different time instants, and an exemplary output 96 showing pressure at different time instants during the BOP operation. FIG. 10 is an exemplary output 98 showing different fields that are displayed in one example, the different components identified through their function names (Upper Annular, Lower Annular, and the like), the Gallon count display will have an actual number associated with the particular component indicating the fluid capacity at a given time, CT is closing time display, where the closing time is calculated by the synchronized model, the plot field provides a graphical output as shown in FIG. 9. Display for status of both, subsea BOP components and surface components, such as an accumulator is available as shown in FIG. 10. In some embodiments, the output may be available separately for subsea components and the surface components.

As mentioned herein above, the one or more model outputs 64 are obtained from the analytical modules described in relation with FIG. 4. At least one analytical module from the plurality of analytical modules is used to calculate closing time for the blowout preventer. The closing time of the blowout preventer is one of the most critical control aspect that ensures a safe operation of the oil well, and protects the uncontrolled release of crude oil and/or natural gas from the well into the sea.

Thus these different aspects of the synchronized model 58 provide unique advantages of replicating in real-time the operation of the BOP, providing useful model outputs, that can be used for monitoring and control of the BOP system, as well as having an ability to be adapted to multiple subsea BOPs, where these multiple subsea BOPs have different configurations.

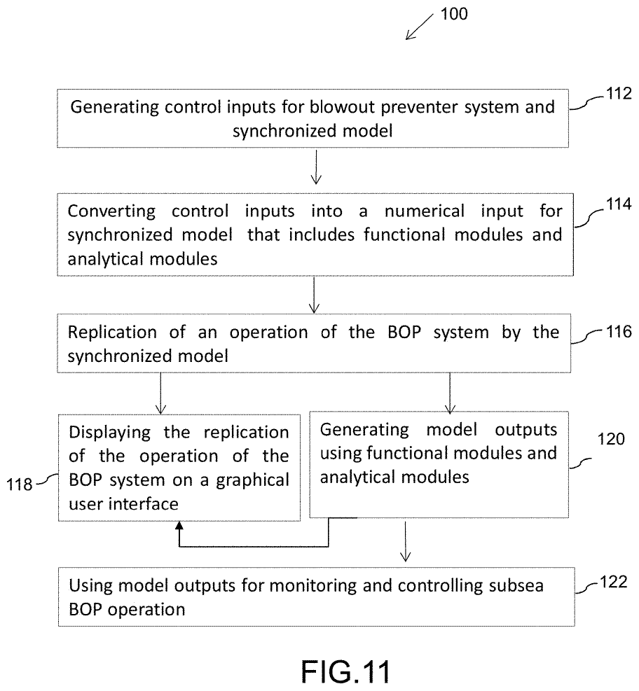

In another aspect, a method for controlling a blowout preventer (BOP) system in an oil rig, is provided and is shown as flowchart 100 in FIG. 11, using a BOP control system described herein above. The method includes a step 112 for generating control inputs for the blowout preventer system and for the synchronized model; converting the control input into numerical input for the synchronized model as shown at step 114, and replicating an operation of the blowout preventer system by using a synchronized model, as shown by step 116, where the synchronized model and the one or more components of the blowout preventer system receive the control inputs simultaneously. As mentioned herein above, for the synchronized model, the control inputs are converted into the numerical input that is used for replicating the operation of the blowout preventer system, using a processor and displayed on a graphical user interface as shown by step 118. The synchronized model includes modular functional modules and analytical modules, and also generates one or more model outputs as shown as step 120 derived from an operation data from the plurality of functional modules, as described herein above in relation to the control system of the invention. The one or more model outputs are used for at least one of monitoring and controlling an operation of the blowout preventer system as shown as step 122. Other aspects of the synchronized model including the aspects related to the functional modules and analytical modules described herein above are also applicable for the method of the invention.

The subsea BOP, though mentioned in singularity herein for ease of understanding, it will include all the different stacks of subsea BOPs associated with the oil rig. The term “exemplary” as used herein means, “by way of an example”.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal. It would be appreciated by those skilled in the art that a communication interface, communicating means, and a communication network will be used that allow the flow of data, user inputs and commands between different components/modules of the control system, for the blowout preventer system, including the synchronized model. It would be understood by those skilled in the art that the communication is based on standard communication protocols and implemented over standard networks used in BOP systems.

It would be further appreciated by those skilled in the art, that the different components/modules including the synchronized model, as well as the method steps described herein, are implemented using embedded hardware and/or software by use of processors, micro-controllers, and/or input/output (I/O) components, microcomputers, programmable logic controllers (PLC), application specific integrated circuits, application-specific processors, digital signal processors (DSPs), Application Specific Integrated Circuits (ASICs), Field Programmable Gate Arrays (FPGAs), and/or any other programmable circuitry, and memory devices. The memory devices may include for example, a dynamic random access memory (DRAM) device, a static random access memory (SRAM) device, a digital versatile disc read only memory (DVD-ROM) device, a digital versatile rewritable (DVD-RW) device, a flash memory device, or other non-volatile, and tangible storage devices. These components are configured as embedded circuitry to perform a variety of computer-implemented functions (e.g., performing the methods, steps, calculations and the like disclosed herein).

It would be also appreciated by those skilled in the art that user inputs, will employ a use of suitable input and output devices including human machine interfaces. The I/O devices may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. In additional embodiments, the I/O devices may include alphanumeric input components (e.g., a keyboard, a touch screen configured to receive alphanumeric input, a photo optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In some embodiments, a non-transitory computer readable medium may be encoded with a program having instructions to instruct the control system to perform functions described for the system and the method of the invention. In another aspect, a computer program product for use with a control system for controlling the blowout preventer system, in an oil rig as described herein, with other aspects of the invention, is also included as an aspect of the invention. The computer program product includes a tangible storage device having program code embodied therewith, the program code is executable by a processor of a computer to perform the method of the invention, wherein the method steps are executed using a processor, tangible storage medium, and communication interfaces as described herein above.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to at least one microcontroller, microcomputer, programmable logic controller (PLC), application specific integrated circuit, and other programmable circuits, and these terms are used interchangeably herein.

The foregoing description is directed to particular embodiments of the present invention for the purpose of illustration and explanation. It will be apparent, however, to one skilled in the art that many modifications and changes to the embodiment set forth above are possible without departing from the scope and the spirit of the invention. It is intended that the following claims be interpreted to embrace all such modifications and changes.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A control system for a blowout preventer (BOP) system in an oil rig, the control system comprising:
an input module for generating one or more control inputs for one or more components of the blowout preventer system, and transmitting the one or more control inputs simultaneously as an operational input and a numerical input, wherein the operational input is transmitted to the one or more components of the blowout preventer system;
a synchronized model coupled to the input module for receiving the numerical input, and for replicating an operation of the blowout preventer system based on the numerical input, and wherein the synchronized model generates one or more model outputs; and
an output module for receiving the one or more model outputs, wherein the one or more model outputs are used for at least one of monitoring and controlling an operation of the blowout preventer system,
wherein the input module, the synchronized model and the output module are implemented using a processor and a tangible storage device.

2. The control system of claim 1 wherein the synchronized model comprises a plurality of functional modules for a desired functionality of the blowout preventer system, wherein the desired functionality is based on connections of the one or more components of the blowout preventer system.

3. The control system of claim 2 wherein each of the plurality of functional modules is configured as a modular module having connectivity flexibility to enable different configurations of the one or more components for the blowout preventer system.

4. The control system of claim 2 wherein the synchronized model comprises a plurality of analytical modules for receiving operation data from the plurality of functional modules, and for determining the one or more model outputs.

5. The control system of claim 1 wherein the operational input is at least one of an electrical input or an acoustic input.

6. A method for controlling a blowout preventer system in an oil rig, the method comprising:
generating one or more control inputs for one or more components of the blowout preventer system, and transmitting the one or more control inputs simultaneously as an operational input and a numerical input, wherein the operational input is transmitted to the corresponding one or more components of the blowout preventer system; and
replicating an operation of the blowout preventer system by using a synchronized model, wherein the synchronized model and the one or more components of the blowout preventer system receive the control inputs simultaneously, and wherein the synchronized model generates one or more model outputs,
wherein the one or more model outputs are used for at least one of monitoring and controlling an operation of the blowout preventer system.

7. The method of claim 6 wherein the synchronized model is used for implementing a plurality of functional modules for each functionality of the blowout preventer system.

8. The method of claim 7 wherein each of the plurality of functional modules is configured as a modular module having connectivity flexibility to enable different configurations of the blowout preventer system.

9. The method of claim 7 wherein the synchronized model is used for implementing a plurality of analytical modules for receiving operation data from the plurality of functional modules, and for determining one or more model outputs.

10. The method of claim 9 wherein the operational input is at least one of an electrical input or an acoustic input.
